(19) United States
(12) Patent Application Publication
(10) Pub. No.: US 2026/0211985 A1
(43) Pub. Date: Jul. 23, 2026

(54) GENERATIVE AI GEOMETRY WATERMARKING

(71) Applicant: AUTODESK, INC., San Francisco, CA (US)

(72) Inventors: Jo Karel VERMEULEN, East York (CA); Justin Frank MATEJKA, Newmarket (CA); George William FITZMAURICE, Toronto (CA)

(21) Appl. No.: 19/291,410

(22) Filed: Aug. 5, 2025

Related U.S. Application Data
(60) Provisional application No. 63/747,819, filed on Jan. 21, 2025.

(51) Int. Cl. G06F 21/16

(52) U.S. Cl. CPC G06F 21/16

(57) ABSTRACT

Various embodiments include a computer-implemented method for embedding a watermark into a design, including identifying a first value corresponding to a first attribute of the design, determining that the first value includes a subset of data that is inaccessible to a user, and embedding the watermark into the design by modifying the first value to indicate that the design was created using a machine learning model.

### CROSS-REFERENCE TO RELATED APPLICATIONS

The present application claims priority benefit of the United States Provisional Patent Application titled, “GENERATIVE AI GEOMETRY WATERMARKING,” having Serial Number 63/747,819 and filed on January 21, 2025. The subject matter of this related application is hereby incorporated herein by reference.

### BACKGROUND

### Field of the Various Embodiments

The present disclosure relates generally to computer science, artificial intelligence, and complex software and, more specifically, to generative AI geometry watermarking.

### Description of the Related Art

In a conventional computer-aided design (CAD) workflow, a designer utilizes various tools included in a CAD program to generate and/or assemble three-dimensional geometry for a design. The tools provided by the CAD program typically allow the designer to manually specify various attributes of the3D geometry or manipulate existing attributes of the 3D geometry in an iterative and incremental manner. Certain types of CAD programs also now provide access to machine learning models that implement generative artificial intelligence (AI) for the automatic generation of 3D geometry based on high-level design criteria. A designer can simply describe high-level design criteria using natural language, and a machine learning model then automatically generates 3D geometry to meet those design criteria. Generative AI is becoming increasingly integrated into modern CAD workflows.

One problem associated with the integration of generative AI into CAD workflows is that designs generated using such generative AI can be indistinguishable from those generated manually by human designers. Consequently, CAD programs that generate designs using generative AI can inadvertently attribute authorship of these designs to a human designer, when attribution should be made to the machine learning models implementing generative AI. This issue presents at least two problems. First, designs generated using generative AI cannot be used in certain situations for legal or contractual reasons. For example, some governments have outlawed the use of designs generated using generative AI for any government projects. Similarly, some customers of design agencies contractually prohibit the use of designs generated using generative AI. Second, members of the design community often wish to know when a design is generated using generative AI rather than by a human designer, because some designers are not comfortable with the integration of generative AI into CAD workflows.

As the foregoing illustrates, what is needed in the art is a technique for identifying when a design was created using generative AI.

### SUMMARY

Various embodiments include a computer-implemented method for embedding a watermark into a design, including identifying a first value corresponding to a first attribute of the design, determining that the first value includes a subset of data that is inaccessible to a user, and embedding the watermark into the design by modifying the first value to indicate that the design was created using a machine learning model.

At least one technical advantage of the disclosed techniques relative to the prior art is that the disclosed techniques enable computer-aided design (CAD) programs to correctly attribute authorship of designs to machine learning models rather than erroneously attributing authorship to a human designer. Accordingly, in situations where designs generated via generative AI are explicitly prohibited, such designs can easily be identified. Another technical advantage of the disclosed techniques is that the disclosed techniques provide a robust mechanism for integrating a watermark into design geometry in a manner that resists removal of the watermark. Accordingly, designs that are created using generative AI and watermarked using the disclosed techniques can be shared amongst different designers while preserving information pertaining to the AI-generated origin of those designs. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a system configured to implement one or more aspects of the invention;

FIG. 2 is a more detailed illustration of the design engine of FIG. 1, according to various embodiments;

FIG. 3 illustrates how the watermark injector of FIG. 2 modifies a portion of design geometry to indicate the usage of generative AI, according to various embodiments;

FIG. 4 illustrates how the watermark injector of FIG. 2 modifies multiple portions of design geometry to indicate the usage of generative AI, according to various embodiments; and

FIG. 5 is a flow diagram of methods steps for injecting a watermark into design geometry created using generative AI, according to various embodiments.

### DETAILED DESCRIPTION OF EXEMPLARY EMBODIMENTS

In the following description, numerous specific details are set forth to provide a more thorough understanding of the various embodiments. However, it will be apparent to one skilled in the art that the inventive concepts may be practiced without one or more of these specific details.

### System Overview

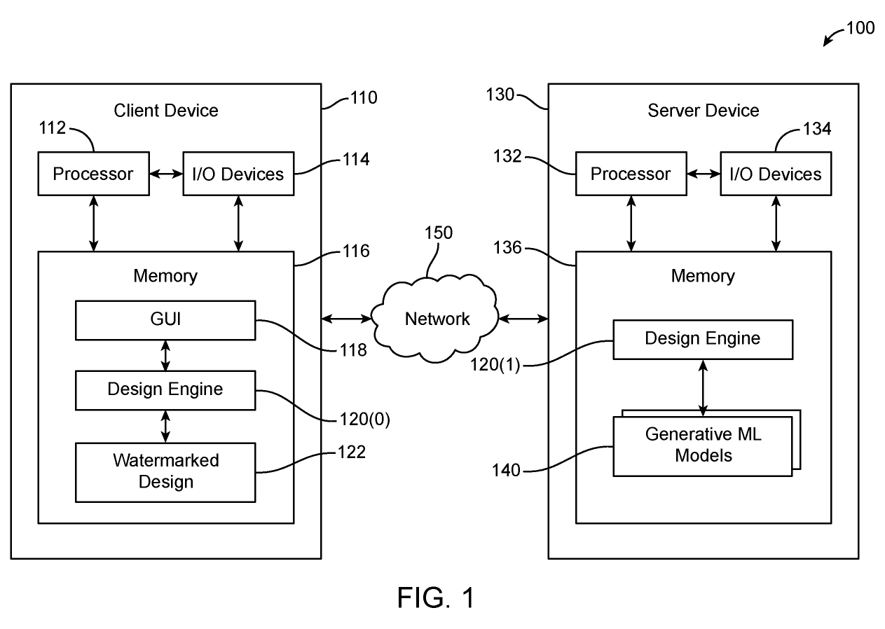

FIG. 1 illustrates a system configured to implement one or more aspects of the various embodiments. As shown, a system 100 includes a client device 110 and a server device 130 coupled together via a network 150. Client device 110 or server device 130 may be any technically feasible type of computer system, including a desktop computer, a laptop computer, a mobile device, a virtualized instance of a computing device, a distributed and/or cloud-based computer system, and so forth. Network 150 may be any technically feasible set of interconnected communication links, including a local area network (LAN), wide area network (WAN), the World Wide Web, or the Internet, among others.

As further shown, client device 110 includes a processor 112, input/output (I/O) devices 114, and a memory 116, coupled together. Processor 112 includes any technically feasible set of hardware units configured to process data and execute software applications. For example, and without limitation, processor 112 could include one or more central processing units (CPUs) and/or one or more graphics processing units (GPUs). I/O devices 114 include any technically feasible set of devices configured to perform input and/or output operations, including, for example and without limitation, a display device, a keyboard, and/or a touchscreen, among others.

Memory 116 includes any technically feasible storage media configured to store data and software applications, such as, for example and without limitation, a hard disk, a random-access memory (RAM) module, and/or a read-only memory (ROM). Memory 116 includes a graphical user interface (GUI) 118, a design engine 120(0), and a watermarked design 122. Design engine 120(0) is a software application that, when executed by processor 112, interoperates with a corresponding software application executing on server device 130 to generate watermarked design 122 based on input received from a user via GUI 118. GUI 118 includes user interface elements that, when displayed to a user via a display device, allow a user to provide various types of input and receive various types of output.

Server 130 includes a processor 132, I/O devices 134, and a memory 136, coupled together. Processor 132 includes any technically feasible set of hardware units configured to process data and execute software applications, such as one or more CPUs and/or one or more GPUs. I/O devices 134 include any technically feasible set of devices configured to perform input and/or output operations, such as, for example and without limitation, a display device, a keyboard, and/or a touchscreen, among others.

Memory 136 includes any technically feasible storage media configured to store data and software applications, such as, for example and without limitation, a hard disk, a RAM module, and/or a ROM. Memory 136 includes a design engine 120(1) and one or more generative machine learning (ML) models 140. Generative ML models 140 are trained using vast amounts of data to process to multi-modal prompts using techniques associated with generative AI. Generative ML models 140 can include large language models (LLMs), visual language models (VLMs), other transformer-based models, deep neural networks (DNNs), convolutional neural networks (CNNs), or any other technically feasible set of algorithms configured to generate design geometry based on natural language and/or other inputs. In one embodiment, generative ML models 140 may be configured to interact with one or more application programming interface (API) endpoints in order to transmit prompts and receive responses from other ML models located on one or more remote servers. In operation,

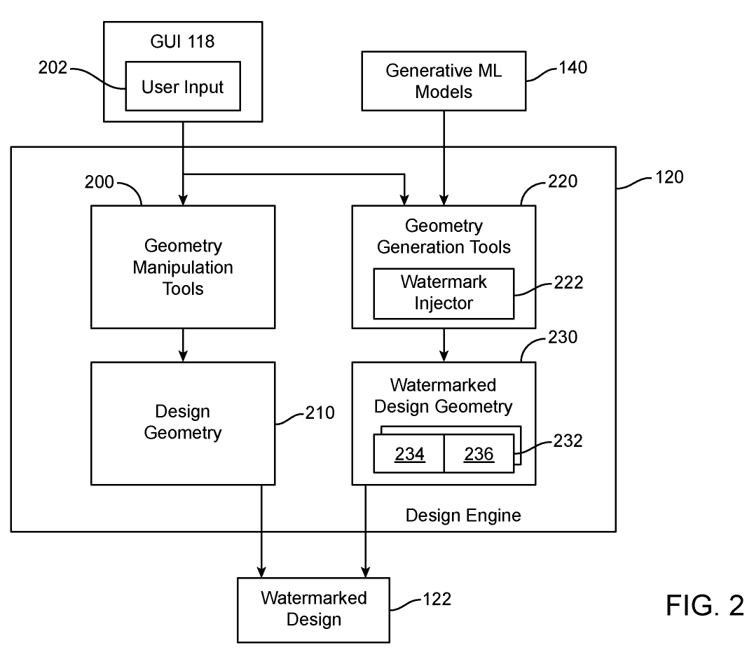

Design engine 120(1) is a software application that, when executed by processor 132, interoperates with design engine 120(0) executing on client 110 to coordinate any of the different operations described herein. Design engines 120(0) and 120(1) represent separate portions of a distributed software entity that is configured to perform any and all of the various operations described herein. Thus, for simplicity, design engines 120(0) and 120(1) are collectively referred to hereinafter as design engine 120. Design engine 120 is configured to interact with GUI 118 in order to expose to a user a CAD environment via which the user can provide input for generating two-dimensional (2D) and/or three-dimensional (3D) designs, including watermarked design 122. In some modes of operation, design engine 120 receives user input that directly specifies various attributes of design geometry associated with a design. In other modes of operation, design engine 120 receives user input that describes design criteria and/or design constraints that design geometry should meet, and design engine 120 then interacts with generative ML models 140 to generate that design geometry using generative AI. In the latter case, design engine 120 injects a watermark into the design geometry indicating that generative AI was used to create the design geometry. The various operations performed by design engine 120 are described in greater detail below in conjunction with FIG. 2.

### Geometry Watermarking

FIG. 2 is a more detailed illustration of the design engine of FIG. 1, according to various embodiments. As shown, design engine 120 includes geometry manipulation tools 200, design geometry 210, geometry generation tools 220, and watermarked design geometry 230. Geometry manipulation tools 200 receive user input 202 that directly specifies various attributes of design geometry 210, including points, vertices, polygons, angles, dimensions, and any other technically feasible feature commonly found in engineering designs generated via CAD programs. Geometry manipulation tools 200 can be exposed to the user via GUI 118. Based on interactions with GUI 118, geometry manipulation tools 200 create design geometry 210. Design geometry generally includes vertices that define a 3D object or collection of 3D objects and can have any technically feasible format configured to represent 3D object(s).

Geometry generation tools 220 receive user input 202 that describes design criteria and/or design constraints that design geometry should meet. Geometry generation tools 220 then implement generative ML models 140 to generate design geometry, via generative AI techniques, to meet these design criteria and/or design constraints. Geometry generation tools 220 include a watermark injector 222 that is configured to modify one or more portions of design geometry produced via generative ML models 140 to generate watermarked design geometry 230.

Watermarked design geometry 230 includes one or more attributes 232 that include an original portion 234 and a watermarked portion 236. A given attribute 232 could be, for example, a dimension, a ratio, a scaling factor, a distance, an angle, and forth, without limitation. A given attribute 232 can be expressed numerically via a set of digits that includes one or more significant digits and one or more insignificant digits. Original portion 234 includes the significant digit(s) whereas watermarked portion includes the insignificant digit(s). Watermark injector 222 is configured to modify the insignificant digit(s) of one or more attributes 232 in order to indicate that the design geometry was created using generative AI versus traditional CAD techniques. The insignificant digits of a given attribute 232 are generally outside of a display or manufacturing resolution with which the design is viewed or fabricated, respectively, and are generally unimportant and/or irrelevant to the user. In various embodiments, the insignificant digits may also be inaccessible to the user. Based on design geometry 210 and watermarked design geometry 230, design engine 120 generates watermarked design 122.

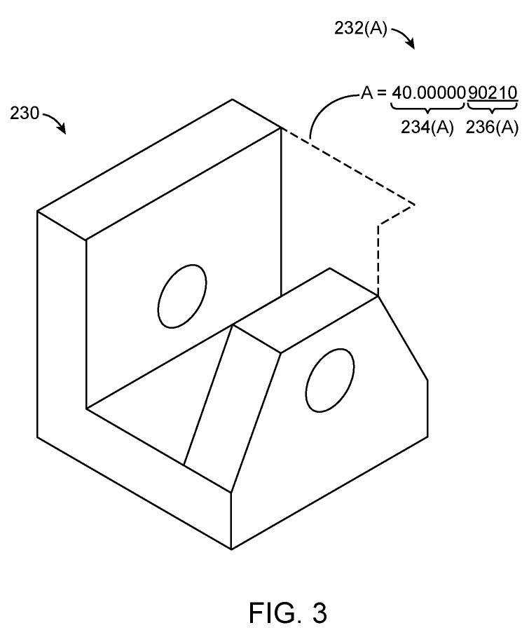

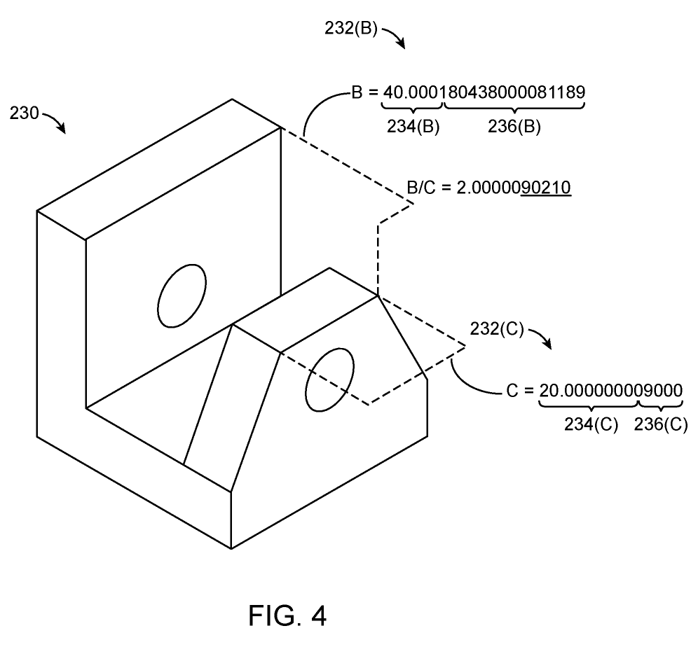

Watermarked design 122 can be represented in a format that prevents direct manipulation of attribute(s) 232, preserving the integrity of the watermarking process described above and helping to ensure that designs produced using generative AI are designated as such. These techniques can help prevent designs produced via generative AI from being used in environments where such designs are prohibited. FIGS. 3-4 set forth examples of how watermark injector 222 watermarks a design.

FIG. 3 illustrates how the watermark injector of FIG. 2 modifies a portion of design geometry to indicate the usage of generative AI, according to various embodiments. As shown, a 3D part 230 includes a dimension 232(A). Dimension 232(A) includes significant digits 234(A) and insignificant digits 236(A). Significant digits 234(A) have a precision that is within the display resolution of a display device configured to display 3D part 230 and/or a manufacturing tolerance with which the 3D part 230 can be fabricated. Insignificant digits 236(A) have a precision that exceeds the display resolution and/or manufacturing tolerance and therefore can be modified without affecting the display or manufacture of 3D part 230. Further, because insignificant digits 236(A) are unimportant and/or irrelevant to the user, these digits can be modified without affecting user experience.

In the example shown, watermark injector 222 modifies dimension 232(A) to include watermark “90210.” Watermark 90210 can be a random identifier meant only to indicate that generative AI was used to create 3D part 230, or a meaningful identifier corresponding to a user, a software license, a software version, a software distributor, a company, and/or a modification timestamp, among others. Any technically feasible information can be included within insignificant digits 236(A). Watermark injector 222 can also modify multiple attributes 232 of design geometry for watermarking purposes, as described below in conjunction with FIG. 4.

FIG. 4 illustrates how the watermark injector of FIG. 2 modifies multiple portions of design geometry to indicate the usage of generative AI, according to various embodiments. As shown, 3D part 230 includes dimensions 232(B) and 232(C). Dimension 232(B) includes significant digits 234(B) and insignificant digits 236(B). Similarly, dimension 232(C) includes significant digits 234(C) and insignificant digits 236(C). Significant digits 234(B) and 234(C) have a precision that is within the display resolution of a display device configured to display 3D part 230 and/or a manufacturing tolerance with which 3D part 230 can be fabricated. Insignificant digits 236(B) and 236(C) have a precision that exceeds the display resolution and/or manufacturing tolerance and therefore can be modified without affecting the display or manufacture of 3D part 230. Insignificant digits 236(B) and 236(C) are generally unimportant and/or irrelevant to the user, and in various embodiments can also be inaccessible to the user.

In the example shown, watermark injector 222 modifies dimensions 232(B) and 232(C) so that the quotient of those dimensions have insignificant digits equal to the watermark “90210.” As with the example described in conjunction with FIG. 3, watermark 90210 can be a random identifier meant only to indicate that generative AI was used to create 3D part 230, or a meaningful identifier corresponding to a user, a software license, a software version, a software distributor, a company, and/or a modification timestamp, among others. As a general matter, any technically feasible information can be encoded within insignificant digits 236(B) and 236(C) such that operations performed on those value produce a watermark indicating that generative AI was used to create 3D model 230. One advantage of the technique described in conjunction with FIG. 4 is that scaling operations performed on 3D part 230 do not affect the watermark, because both of dimensions 232(B) and 232(C) would be subject to the same scaling factors.

Referring generally to FIGS. 3-4, the techniques described herein provide a robust approach for embedding identifiers in design geometry that can be used to indicate the usage of generative AI techniques. Those skilled in the art will recognize that the disclosed techniques can be applied in order to include any other technically feasible type of metadata as well. Metadata embedded in the manner described cannot easily be modified by a user for at least two reasons. First, insignificant digits 236 are generally unimportant and/or irrelevant to the user and therefore typically not displayed to the user and, further, in various embodiments cannot be accessed by the user via the GUI 118 or other means. Second, a typical file format used for storing watermarked design 122 cannot easily be opened and manipulated directly, making the insignificant digits of various attributes potentially inaccessible. Accordingly, the watermarking process described herein is relatively resistant to potential tampering. When displaying 3D geometry associated with a design that includes a watermark such as that described, design engine 120 in conjunction with GUI 118 can detect the presence of the watermark and then indicate to the user that generative AI was used to create the design.

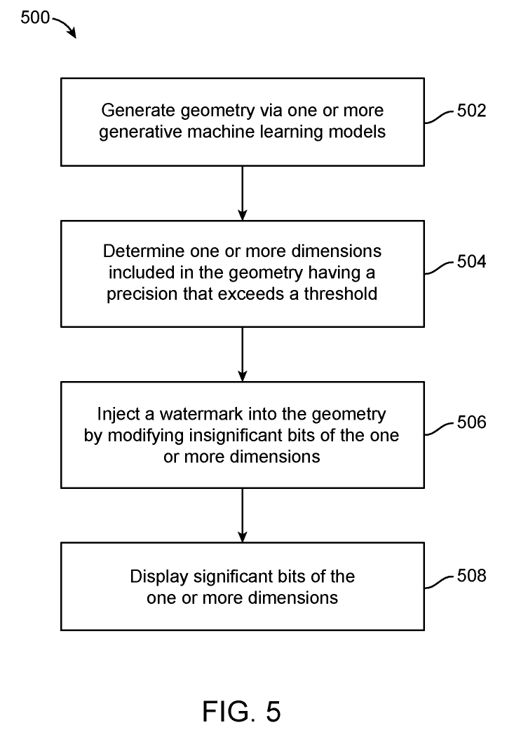

FIG. 5 is a flow diagram of methods steps for injecting a watermark into design geometry created using generative AI, according to various embodiments. Although the method steps are described in conjunction with the systems of FIGS. 1-4, persons skilled in the art will understand that any system configured to perform the method steps, in any order, is within the scope of the present embodiments.

As shown, a method 500 begins at step 502, where geometry generation tools 220 generate design geometry via one or more generative machine learning models 140. Geometry generation tools 220 receive user input 202 that describes design criteria and/or design constraints that design geometry should meet, and then implement one or more generative ML models 140 to generate design geometry, via generative AI techniques, that meet these design criteria and/or design constraints. Geometry generation tools 220 include watermark injector 222.

At step 504, watermark injector 222 determines one or more dimensions having a precision that exceeds a threshold. A given attribute is expressed numerically and typically includes significant digits that have a precision within a relevant display resolution and/or a manufacturing tolerance as well as insignificant digits that have a precision beyond the display resolution and/or manufacturing tolerance. These insignificant digits can be modified without affecting the display or manufacture of 3D part 230. Design engine 120 can determine the threshold based on the relevant display resolution and/or manufacturing tolerance.

At step 506, watermark injector 222 injects a watermark into the design geometry by modifying one or more insignificant bits of the one or more dimensions. Watermark injector 222 can update the insignificant digits of a given dimension to include an identifier corresponding to a user, a software license, a software version, a software distributor, a company, and/or a modification timestamp, among others. Watermark injector 222 can also modify multiple dimensions such that operations performed on these dimensions produce an identifier.

At step 508, GUI 118 displays the significant bits of the one or more dimensions. GUI 118 generally does not and/or cannot display or provide any access to the insignificant digits modified via watermark injector 222, thereby providing a robust technique for embedding metadata in 3D models that can be applied to designate when a design was created using generative AI. Subsequently, GUI 118 can detect the presence of the watermark based on the insignificant digits included in the one or more dimensions, and then output an indication that the design was created using generative AI.

In sum, a design engine includes a watermark injector configured to indicate when a design has been generated using generative artificial intelligence (AI). The design engine includes conventional geometry manipulation tools that are configured to generate design geometry in response to user input. The design engine also includes geometry generation tools that leverage generative models to automatically generate design geometry in response to prompts received from the user. The watermark injector identifies one or more portions of the design geometry that can be modified without affecting the display or manufacture of the design, and subsequently updates such portions to include a watermark indicating that generative AI was used to generate the design. In practice, the watermark injector identifies insignificant digits associated with one or more dimensions of the design geometry that are beyond the display or manufacturing capabilities where the design is intended to be used, and then modifies these digits to include the watermark. Subsequently, rendering applications configured to render and display the design can detect the presence of the identifier in the insignificant digits and then indicate that the design has been generated using generative AI.

At least one technical advantage of the disclosed techniques relative to the prior art is that the disclosed techniques enable computer-aided design (CAD) programs to correctly attribute authorship of designs to machine learning models rather than erroneously attributing authorship to a human designer. Accordingly, in situations where designs generated via generative AI are explicitly prohibited, such designs can easily be identified. Another technical advantage of the disclosed techniques is that the disclosed techniques provide a robust mechanism for integrating a watermark into design geometry in a manner that resists removal of the watermark. Accordingly, designs that are created using generative AI and watermarked using the disclosed techniques can be shared amongst different designers while preserving information pertaining to the AI-generated origin of those designs. These technical advantages provide one or more technological advancements over prior art approaches.

1. Some embodiments include a computer-implemented method for embedding a watermark into a design, the method comprising identifying a first value corresponding to a first attribute of the design, determining that the first value includes a subset of data that is inaccessible to a user, and embedding the watermark into the design by modifying the first value to indicate that the design was created using a machine learning model.

2. The computer-implemented method of clause 1, wherein the first attribute of the design comprises at least one of a ratio, a scaling factor, a distance, or an angle associated with the design.

3. The computer-implemented method of any of clauses 1-2, wherein the first value includes one or more significant digits and one or more insignificant digits, wherein the subset of data that is inaccessible to the user includes the one or more insignificant digits, and wherein embedding the watermark into the design comprises modifying the one or more insignificant digits.

4. The computer-implemented method of any of clauses 1-3, wherein embedding the watermark into the design comprises including an identifier in the first value that corresponds to at least one of a user, a software license, a software version, a software distributor, a company, or a modification timestamp.

5. The computer-implemented method of any of clauses 1-4, wherein identifying the first value comprises determining that at least a portion of the first value has a numerical precision that exceeds a threshold.

6. The computer-implemented method of any of clauses 1-5, wherein identifying the first value comprises determining that at least a portion of the first value has a numerical precision that exceeds a display resolution with which the design is displayed.

7. The computer-implemented method of any of clauses 1-6, wherein identifying the first value comprises determining that at least a portion of the first value has a numerical precision that exceeds a manufacturing tolerance with which the design is fabricated.

8. The computer-implemented method of any of clauses 1-7, further comprising identifying a second value corresponding to a second attribute of the design, modifying the second value to indicate that the design was created using the machine learning model, and analyzing the first value and the second value to extract an identifier indicating that the design was created using the machine learning model.

9. The computer-implemented method of any of clauses 1-8, further comprising analyzing the first value in conjunction with a second value corresponding to a second attribute of the design to determine that the design was created using a machine learning model, wherein the watermark includes the first value and the second value.

10. The computer-implemented method of any of clauses 1-9, further comprising causing the machine learning model to create at least a portion of the design by transmitting a prompt to the machine learning model indicating at least one design criteria associated with the design.

11. One or more non-transitory computer readable media storing instructions that, when executed by one or more processors, cause the one or more processors to embed a watermark into a design by performing the steps of identifying a first value corresponding to a first attribute of the design, determining that the first value includes a subset of data that is inaccessible to a user, and embedding the watermark into the design by modifying the first value to indicate that the design was created using a machine learning model.

12. The one or more non-transitory computer readable media of any of clauses 1-11, wherein the first attribute of the design comprises at least one of a ratio, a scaling factor, a distance, or an angle associated with the design, wherein the first value includes one or more significant digits and one or more insignificant digits, wherein the subset of data that is inaccessible to the user includes the one or more insignificant digits, and wherein the step of embedding the watermark into the design comprises modifying the one or more insignificant digits.

13. The one or more non-transitory computer readable media of any of clauses 1-12, wherein the step of embedding the watermark into the design comprises including an identifier in the first value that corresponds to at least one of a user, a software license, a software version, a software distributor, a company, or a modification timestamp.

14. The one or more non-transitory computer readable media of any of clauses 1-13, wherein the step of identifying the first value comprises determining that at least a portion of the first value has a numerical precision that exceeds a threshold or has a numerical precision that exceeds a display resolution with which the design is displayed.

15. The one or more non-transitory computer readable media of any of clauses 1-14, further comprising the steps of identifying a second value corresponding to a second attribute of the design, modifying the second value to indicate that the design was created using the machine learning model, and analyzing the first value and the second value to extract an identifier indicating that the design was created using the machine learning model.

16. The one or more non-transitory computer readable media of any of clauses 1-15, further comprising the step of analyzing the first value in conjunction with a second value corresponding to a second attribute of the design to determine that the design was created using a machine learning model.

17. The one or more non-transitory computer readable media of any of clauses 1-16, further comprising the step of causing the machine learning model to create at least a portion of the design by transmitting a prompt to the machine learning model indicating at least one design criteria associated with the design.

19. The one or more non-transitory computer readable media of any of clauses 1-18, wherein the design includes three-dimensional geometry associated with a computer-aided design format.

20. Some embodiments include a computer system, comprising one or more memories that include instructions, and one or more processors that are coupled to the one or more memories and, when executing the instructions, are configured to embed a watermark into a design by identifying a first value corresponding to a first attribute of the design, determining that the first value includes a subset of data that is inaccessible to a user, and embedding the watermark into the design by modifying the first value to indicate that the design was created using a machine learning model.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for embedding a watermark into a design, the method comprising:
identifying a first value corresponding to a first attribute of the design;
determining that the first value includes a subset of data that is inaccessible to a user; and
embedding the watermark into the design by modifying the first value to indicate that the design was created using a machine learning model.

2. The computer-implemented method of claim 1, wherein the first attribute of the design comprises at least one of a ratio, a scaling factor, a distance, or an angle associated with the design.

3. The computer-implemented method of claim 1, wherein the first value includes one or more significant digits and one or more insignificant digits, wherein the subset of data that is inaccessible to the user includes the one or more insignificant digits, and wherein embedding the watermark into the design comprises modifying the one or more insignificant digits.

4. The computer-implemented method of claim 1, wherein embedding the watermark into the design comprises including an identifier in the first value that corresponds to at least one of a user, a software license, a software version, a software distributor, a company, or a modification timestamp.

5. The computer-implemented method of claim 1, wherein identifying the first value comprises determining that at least a portion of the first value has a numerical precision that exceeds a threshold.

6. The computer-implemented method of claim 1, wherein identifying the first value comprises determining that at least a portion of the first value has a numerical precision that exceeds a display resolution with which the design is displayed.

7. The computer-implemented method of claim 1, wherein identifying the first value comprises determining that at least a portion of the first value has a numerical precision that exceeds a manufacturing tolerance with which the design is fabricated.

8. The computer-implemented method of claim 1, further comprising:
identifying a second value corresponding to a second attribute of the design;
modifying the second value to indicate that the design was created using the machine learning model; and
analyzing the first value and the second value to extract an identifier indicating that the design was created using the machine learning model.

9. The computer-implemented method of claim 1, further comprising analyzing the first value in conjunction with a second value corresponding to a second attribute of the design to determine that the design was created using a machine learning model, wherein the watermark includes the first value and the second value.

10. The computer-implemented method of claim 1, further comprising causing the machine learning model to create at least a portion of the design by transmitting a prompt to the machine learning model indicating at least one design criteria associated with the design.

11. One or more non-transitory computer readable media storing instructions that, when executed by one or more processors, cause the one or more processors to embed a watermark into a design by performing the steps of:
identifying a first value corresponding to a first attribute of the design;
determining that the first value includes a subset of data that is inaccessible to a user; and
embedding the watermark into the design by modifying the first value to indicate that the design was created using a machine learning model.

12. The one or more non-transitory computer readable media of claim 11, wherein the first attribute of the design comprises at least one of a ratio, a scaling factor, a distance, or an angle associated with the design, wherein the first value includes one or more significant digits and one or more insignificant digits, wherein the subset of data that is inaccessible to the user includes the one or more insignificant digits, and wherein the step of embedding the watermark into the design comprises modifying the one or more insignificant digits.

13. The one or more non-transitory computer readable media of claim 11, wherein the step of embedding the watermark into the design comprises including an identifier in the first value that corresponds to at least one of a user, a software license, a software version, a software distributor, a company, or a modification timestamp.

14. The one or more non-transitory computer readable media of claim 11, wherein the step of identifying the first value comprises determining that at least a portion of the first value has a numerical precision that exceeds a threshold or has a numerical precision that exceeds a display resolution with which the design is displayed.

15. The one or more non-transitory computer readable media of claim 11, further comprising the steps of:
identifying a second value corresponding to a second attribute of the design;
modifying the second value to indicate that the design was created using the machine learning model; and
analyzing the first value and the second value to extract an identifier indicating that the design was created using the machine learning model.

16. The one or more non-transitory computer readable media of claim 11, further comprising the step of analyzing the first value in conjunction with a second value corresponding to a second attribute of the design to determine that the design was created using a machine learning model.

17. The one or more non-transitory computer readable media of claim 11, further comprising the step of causing the machine learning model to create at least a portion of the design by transmitting a prompt to the machine learning model indicating at least one design criteria associated with the design.

1818 The one or more non-transitory computer readable media of claim 11, wherein the machine learning model implements generative artificial intelligence to generate a portion of the design that includes the first attribute.

19. The one or more non-transitory computer readable media of claim 11, wherein the design includes three-dimensional geometry associated with a computer-aided design format.

20. A computer system, comprising:
one or more memories that include instructions; and
one or more processors that are coupled to the one or more memories and, when executing the instructions, are configured to embed a watermark into a design by:
identifying a first value corresponding to a first attribute of the design,
determining that the first value includes a subset of data that is inaccessible to a user, and
embedding the watermark into the design by modifying the first value to indicate that the design was created using a machine learning model.
